(19) United States
(12) Patent Application Publication
(10) Pub. No.: US 2026/0189110 A1
(43) Pub. Date: Jul. 2, 2026

(54) DISCHARGE DEVICE FOR DISCHARGING AN ELECTRIC CHARGE AND/OR VOLTAGE VIA A SHAFT OF A DRIVE TRAIN, AND DRIVE TRAIN HAVING THE DISCHARGE DEVICE

(71) Applicant: Schaeffler Technologies AG & Co. KG, Herzogenaurach (DE)

(72) Inventor: Christian Hartmann, Emskirchen (DE)

(73) Assignee: Schaeffler Technologies AG & Co. KG, Herzogenaurach (DE)

(21) Appl. No.: 18/868,172

(22) PCT Filed: Apr. 21, 2023
(86) PCT No.: PCT/DE2023/100287

§ 371 Date: Nov. 22, 2024

(30) Foreign Application Priority Data
May 25, 2022 (DE) 10 2022 113 208.0

(51) Int. Cl. H02K 11/40; H02K 5/124; H02K 7/00; H02K 7/08

(52) U.S. Cl. CPC H02K 11/40; H02K 5/124; H02K 7/003; H02K 7/006; H02K 7/08

(57) ABSTRACT

A discharge device for an electric machine for discharging an electric charge and/or voltage from a rotor to a housing portion via a shaft, the housing portion delimiting a housing chamber. The discharge device comprises a first contact means for electrically and mechanically connecting to the shaft and a second contact means for electrically and mechanically connecting to the housing portion. The first and the second contact means can be rotated relative to each other about a main axis. The one contact means is in the form of a sleeve and the other contact means is in the form of a grounding rod, the sleeve having a contact chamber with an electrically conductive liquid, the grounding rod being disposed partly in the sleeve, and the sleeve and the grounding rod being electrically interconnected by the interposition of the electrically conductive liquid. The discharge device also comprises a bridging sleeve, the bridging sleeve being disposed in the contact chamber, and the bridging sleeve electrically bridging the distance between the grounding rod and the sleeve at least partially.

### CROSS-REFERENCE TO RELATED APPLICATIONS

This application is the U.S. National Phase of PCT Appln. No. PCT/DE2023/100287 filed Apr. 21, 2023, which claims priority to DE 10 2022 113 208.0 filed May 25, 2022, the entire disclosures of which are incorporated by reference herein.

### TECHNICAL FIELD

The disclosure relates to a discharge device. The disclosure further relates to a drive train comprising the discharge device.

### BACKGROUND

Electric machines, especially electric traction machines, are electrically charged during operation by induced shaft voltages. In addition, circulating high-frequency currents can arise in high-power motors. Such electric machines usually have a rotor and a rotor shaft, which are mounted in a housing via rolling bearings. Owing to electrical discharges or circulating high-frequency currents, rolling bearings may be damaged. To avoid this, it is necessary to dissipate this electrical energy. For example, earthing brushes or radially acting abrasive elements (carbon brushes) are known, which serve to ground the rotor shaft. Furthermore, axially acting systems for shaft grounding are known.

Document DE 10 2020 119 719 A1, which represents the closest prior art, discloses a discharge means for a motor for discharging an electrical charge and/or voltage from a rotor via a shaft to a housing, comprising a first contact module for electrically and mechanically connecting to the shaft, a second contact module for electrically and mechanically connecting to the housing, wherein the first and the second contact module can be rotated relative to each other and electrically connected to one another in an interior space sealed off from a housing chamber, the interior space being filled with an electrically conductive liquid, and the first contact module and the second contact module being electrically interconnected via the electrically conductive liquid.

### SUMMARY

The disclosure is based on the object of creating a discharge device which is characterized by an improved discharge capacity and freedom from wear.

This object is achieved by a discharge device having the features described herein and by a drive train having the features described herein. Preferred or advantageous embodiments of the disclosure arise from the following description and the attached drawings.

The disclosure relates to a discharge device which is designed and/or is suitable preferably for a drive train with an electric machine. The drive train or the electric machine has a housing portion, wherein the housing portion defines and/or delimits a housing chamber. In particular, the housing portion is a component of a housing and/or forms the same. Preferably, the housing is constructed in several parts, wherein the housing portion forms a part of the housing, for example a bearing plate. In particular, the housing portion is connected to ground and/or is grounded.

The electric machine has a shaft or is coupled to a shaft, e.g. an input shaft or an intermediate shaft of a transmission, which defines a main axis with its axis of rotation. Moreover, the electric machine has a stator and a rotor, which are concentrically and/or coaxially disposed with respect to one another. The shaft is connected to the rotor electrically and for transmission. In particular, the shaft is driven via and/or by the rotor. In particular, the shaft is designed as a rotor shaft, which is preferably connected to the rotor in a rotationally fixed, rigid and/or integral manner. Preferably, the housing portion is electrically and mechanically connected to the stator of the electric motor.

The shaft and, optionally, the rotor are rotatably mounted in the housing chamber. In particular, the electric machine has at least or exactly two bearing means which form or help form the rotor bearing assembly. The rotor is preferably disposed between the two bearing means in the housing chamber, the shaft being rotatably mounted via the bearing means in the housing chamber and/or on the housing portion. Preferably, at least one of the bearing means is designed as a rolling bearing means.

The discharge device is designed and/or is suitable for discharging an electrical charge and/or voltage, starting from the rotor via the shaft to the housing portion and, optionally additionally, to the stator. In particular, the discharge device forms an electrical connection between the shaft and the housing portion. In particular, there is a permanent electrical connection between the shaft and the housing portion, both statically and dynamically, i.e. during operation of the electric machine.

The discharge device has a first contact means and a second contact means. The first contact means is used for electrically connecting to the shaft. Furthermore, the first contact means is used for mechanically connecting to the shaft, in particular such that the first contact means is fixed to the shaft. The second contact means is used for electrically connecting to the housing portion. Furthermore, the second contact means is used for mechanically connecting to the housing portion, in particular such that the second contact means is fixed to the housing portion. The two contact means can be rotated relative to each other, particularly during operation of the electric machine. During operation of the electric machine, the shaft rotates about the main axis, the first contact means being carried along by the rotating shaft and the second contact means remaining stationary on the housing portion.

The first and the second contact means are electrically connected to each other in a contact chamber that is sealed from the housing chamber. Preferably, the contact chamber and the housing chamber are separated in a sealing manner from and/or sealed against each other. The contact chamber is delimited, in particular in the axial and/or radial direction, by the first and/or the second contact means. Preferably, the contact chamber is defined as an annular space which surrounds the main axis and which is formed between the first and the second contact means. The two contact means are disposed coaxially with respect to one another in relation to the main axis, the first contact means being disposed on an axial end face of the shaft and the second contact means being disposed opposite it on the housing portion. Thus, the discharge device is realized as a so-called “end-face shaft grounding device”. Alternatively, the discharge device can also be installed in a hollow shaft, e.g. when using an oil lance, rather than in the solid shaft.

The contact chamber is filled with an electrically conductive liquid. Preferably, the contact chamber is completely filled with the electrically conductive liquid. Alternatively, the contact chamber can also be partially and/or mostly filled with the electrically conductive liquid. The first and the second contact means are electrically interconnected via the electrically conductive liquid. In particular, the two contact means are spaced apart from one another in the contact chamber, with an electrical contact being made exclusively or additionally via the electrically conductive liquid. In particular, a current path thus runs from the rotor via the shaft and the first contact means by the interposition of the electrically conductive liquid to the second contact means and the housing portion. The current path formed by the discharge device has a lower resistance than the bearing means so that the discharge currents and/or voltages are discharged via the discharge device.

The electrically conductive liquid creates a wear-free contact between the two discharge devices, so the discharge device can be operated with very little friction and without wear. In contrast to friction contacts, as is known from the prior art, the proposed discharge device does not produce any conductive abrasion, thus eliminating the risk of short circuits caused by the abrasion in the electric machine. A further advantage is that the contact via the electrically conductive liquid enables position-independent operation of the discharge device, since permanent contact is established between the two contact means by the interposition of the electrically conductive liquid.

It is provided that one of the contact means is designed as a sleeve and the other contact means as a grounding rod. In principle, the sleeve can be assigned to the housing portion and the grounding rod to the shaft. Preferably, however, the sleeve is assigned to the shaft and the grounding rod to the housing portion. In particular, the sleeve is designed in its basic shape as a cylindrical sleeve closed on one side. In particular, the grounding rod is designed in its basic shape as a cylindrical rod. Preferably, the sleeve and the grounding rod are formed from an electrically conductive material, such as steel, iron, copper or the like. The sleeve comprises the contact chamber with the electrically conductive liquid, wherein the grounding rod is disposed partly in the sleeve so that the grounding rod is immersed in the electrically conductive liquid in the contact chamber. In particular, the grounding rod and the sleeve can be rotated relative to each other about the main axis, the grounding rod and the sleeve being permanently in contact by the interposition of the electrically conductive liquid during a relative rotation. For this purpose, the sleeve and the grounding rod are disposed coaxially in relation to the main axis and/or concentrically with respect to one another. Preferably, the grounding rod is inserted into the sleeve in the axial direction in relation to the main axis and sealed with respect to the sleeve. The contact chamber is delimited in the axial direction on the one hand by the sleeve itself and on the other hand by the grounding rod which is received in the sleeve in a sealing manner. Thus, a discharge device is proposed which is characterized by a simple and cost-effective structure and which can also be easily integrated into an existing system.

Within the scope of the disclosure, it is proposed that the discharge device has a bridging sleeve, the bridging sleeve being disposed in the contact chamber. In particular, the bridging sleeve is designed to be electrically conductive. The bridging sleeve is designed in particular as a separate component to the sleeve. The bridging sleeve bridges the distance, in particular the radial distance, between the grounding rod and the sleeve at least partly and in an electrically conductive manner. The bridging sleeve is in particular made of or comprises an electrically conductive material, preferably a metal. In particular, the grounding rod is disposed in the bridging sleeve and the bridging sleeve bears against the sleeve in the radial direction and/or in the axial direction in the contact chamber. In particular, the bridging sleeve is disposed coaxially with respect to the main axis of rotation and/or concentrically between the grounding rod and the sleeve. In particular, the bridging sleeve is rigidly connected to the sleeve and/or disposed to rotate freely relative to the grounding rod. It can be provided that the grounding rod is disposed in the bridging sleeve in a contacting manner, but preferably the grounding rod is disposed in the bridging sleeve in a contactless manner, e.g. with play, and/or at least only with contact in certain regions. The electrically conductive liquid ensures the electrical contact between the grounding rod and the bridging sleeve.

The bridging sleeve can be designed as an end sleeve and be open only on one side and/or have a blind hole opening for the grounding rod. Preferably, however, it is designed with a through-opening for receiving, at least for partially receiving, the grounding rod. Particularly preferably, the bridging sleeve has a straight hollow cylindrical shape.

It is advantageous that the bridging sleeve can be manufactured in a simple, cost-effective manner with low tolerances and/or high manufacturing quality, in particular in relation to the receiving opening for the grounding rod. This means that it is no longer necessary for the sleeve in the contact chamber to have a high manufacturing quality and/or a low tolerance, since the contact surface to the grounding rod is formed by the inner circumference of the bridging sleeve. In addition, the radial distance between the bridging sleeve, in particular an inner circumference of the bridging sleeve, and the outer circumference of the grounding rod is reduced so that the electrically conductive liquid only has to bridge a very short section in the conduction path between the grounding rod and the bridging sleeve. This increases the conductivity of the discharge device and/or reduces the electrical resistance in the discharge device.

In a preferred development of the disclosure, the bridging sleeve is designed as a sliding bushing, the sliding bushing forming a plain bearing assembly and/or emergency bearing assembly for the grounding rod. This gives the bridging sleeve a second function, namely a bearing function for the grounding rod. The sliding bushing can realize a permanent bearing assembly or a temporary bearing assembly, in particular designed for realizing an emergency running property for the grounding rod in the bridging sleeve. By selecting the bridging sleeve as a separate component to the sleeve, the material of the sliding bushing, for example, can be freely selected so that a low-friction material pairing between the grounding rod and the bridging sleeve can be realized. For example, it is possible to use a soft metal such as a copper alloy, bronze alloy or brass alloy for the bridging sleeve. Alternatively or additionally, it is also possible to apply an additional sliding coating to the inner circumference of the bridging sleeve as a sliding bushing, since this measure for reducing friction with the bridging sleeve can also be realized cost-effectively. In particular, the electrically conductive liquid forms a lubricating film between the grounding rod and the bridging sleeve as a plain bearing partner.

In a preferred embodiment, the bridging sleeve is mechanically and thus electrically conductively connected to the sleeve. For example, the bridging sleeve is pressed into the sleeve and is thus mechanically and consequently electrically conductively connected to the sleeve. Optionally, the bridging sleeve can be integrally connected to the sleeve. It is provided that the electrically conductive liquid only electrically conductively bridges a possible annular gap between the bridging sleeve and the grounding rod. During operation, the relative rotation between the sleeve and the grounding rod can lead to contact, possibly permanent contact. However, this contact is not reliable; process reliability is only achieved by the electrically conductive liquid in the annular gap. Strictly speaking, it is not always necessary to provide an annular gap between the bridging sleeve and the grounding rod.

In a preferred development of the disclosure, the annular gap has a simple annular gap width, i.e. a distance between the inner circumference of the bridging sleeve and the outer circumference of the grounding rod of less than 200 μm, preferably less than 60 μm and in particular less than 30 μm. The small annular gap width increases the electrical conductivity and/or reduces the electrical resistance of the discharge device.

Preferably, the electrically conductive liquid itself is electrically conductive and/or is mixed with electrically conductive additives. In principle, the electrically conductive liquid can be formed as a liquid metal or an ionic liquid or the like. However, the electrically conductive liquid is preferably in the form of a conductive oil or grease. Although conductive oils and greases generally have a lower conductivity than, for example, liquid metal, they are less toxic and/or easier to handle. Use of the bridging sleeve compensates for the lower conductivity, so the bridging sleeve enables technically reasonable use of conductive oils and/or greases. In particular, an electrically conductive liquid with an electrical conductivity at 25° C. of more than 10,000 nS/m, in particular more than 30,000 nS/m, is used, such as oils or greases with conductive additives or other oil-free and/or fat-free liquids. These are particularly suitable for low-impedance applications.

For lower requirements on transmission resistance, i.e. for higher transmission resistances, even conventional transmission oils can be used because of the bridging sleeve.

In an alternative embodiment, the electrically conductive liquid then has an electrical conductivity at 25° C. of less than 500 nS/m, preferably less than 300 nS/m and in particular less than 100 nS/m or less than 50 nS/m. On the other hand, it is preferred that the electrical conductivity is greater than 1 nS/m, preferably greater than 5 nS/m and in particular greater than 10 nS/m. This electrical conductivity makes it possible to use transmission oils as they are commonly used, so specially adapted liquids, especially those with conductive additives, can be dispensed with. This is made possible by the use of the bridging sleeve and the resulting reduced annular gap width.

Furthermore, the conductive oils and/or greases improve the emergency running properties of the grounding rod in the bridging sleeve.

Particularly preferably, the sleeve has a radial shoulder, in particular a taper and/or step, the bridging sleeve being form-fittingly secured in the axial direction by the radial shoulder in the contact chamber. Preferably, the bridging sleeve is inserted and/or pressed into the contact chamber during production and the radial shoulder is subsequently produced by forming, such that the bridging sleeve is captive in the contact chamber.

More specifically, the sleeve has a sealing portion for receiving a sealing means and a contact portion adjoining the sealing portion to form the contact chamber. In particular, the contact portion directly adjoins the sealing portion in the axial direction in relation to the main axis. The sleeve can be designed as a shaped sheet-metal component, the contact portion and the sealing portion being made by forming. Preferably, the grounding rod is supported in a sealing manner on the sleeve within the sealing portion and/or guided in a sealing manner via the sealing portion. Preferably, the contact portion is closed in an axial direction in relation to the main axis and the sealing portion is open in an opposite axial direction, such that the grounding rod is and/or can be inserted into the contact portion in the axial direction via the sealing portion. For example, the contact portion is pre-filled with the electrically conductive liquid before the grounding rod is installed, and the grounding rod is immersed in the electrically conductive liquid when inserted into the sleeve and/or closes the contact chamber in a fluid-tight manner. A discharge device is proposed which is characterized by simple assembly and thus by simple and cost-effective installation.

In a further specific embodiment, the discharge device has a sealing means which is designed and/or is suitable for sealing the contact chamber. In particular, the sealing means has the function of protecting the contact chamber with respect to the surroundings, in particular the housing chamber, against an escape of the electrically conductive liquid and/or against an ingress of foreign particles, such as dust, moisture, spray water, oil, etc., from the surroundings. For this purpose, the contact chamber is preferably designed to be closed and separated from the surroundings in the axial direction by the sealing means. In particular, the sealing means is used for the dynamic and static sealing of the contact chamber so that it is sealed with respect to the surroundings, in particular the housing chamber, both when at a standstill and during operation. Preferably, the sealing means forms a fluid-tight, in particular oil-tight, separation of the contact chamber. The sealing means is received form-fittingly and/or frictionally in the sealing portion in an axial direction, in relation to the main axis, and the grounding rod is supported in a sealing manner on an inner circumference of the sleeve via the sealing means. In particular, the sealing means is held frictionally in the sealing portion by a press fit. Alternatively or optionally in addition, the sealing means is held form-fittingly in the axial direction and/or in the opposite axial direction. Preferably, the sealing means is designed as a contacting rotary seal, for example as a radial shaft sealing ring, a felt ring or a shaft lip seal. Therefore, a particularly impermeable system is proposed which can be used in both dry and wet environments, for example.

In a further development, the sealing means is designed as a double-acting rotary seal. For this purpose, the sealing means has a first sealing lip and a second sealing lip, which run radially at a distance from one another in the axial direction on an outer circumference of the grounding rod. In principle, the first and second sealing lips can each be formed by two separate seals, e.g. radial shaft sealing rings. Preferably, however, the sealing means has a cylindrical main body, and the two sealing lips are formed on an inner circumference of the main body. In particular, the main body and the two sealing lips are made of an elastic material. Alternatively, the main body can be made of a harder material than the two sealing lips, e.g. a hard plastic, metal or the suchlike. The two sealing lips ensure a particularly high degree of sealing, especially during rotation of the shaft, wherein escape of the electrically conductive liquid or the ingress of foreign particles is significantly reduced or prevented.

In a further embodiment, the sleeve has a form-fitting contour on its inner circumference and the grounding rod has a counter-contour on its outer circumference. The form-fitting contour and the counter-contour are form-fittingly engaged with each other in the axial direction in relation to the main axis so that the grounding rod is secured against being pulled out of the sleeve. Preferably, the grounding rod is secured to the sleeve via the form-fitting contour at a fixed insertion depth. In particular, the form-fitting contour can be formed by at least one radially inwardly directed collar and the counter-contour by at least one radially outwardly directed collar, such that an end stop for the grounding rod is formed at least in one axial direction from the sleeve. In particular, the form-fitting contour or the counter-contour has a further collar so that an end stop for the grounding rod is formed both in the axial direction and in the opposite axial direction. Thus, the grounding rod can be rotated in the circumferential direction and is secured against displacement in the sleeve in the axial direction. Thus, a discharge device is proposed which is designed as a pre-assembled unit.

In a further embodiment, it is provided that the second contact means has a fastening portion at the end. In particular, the fastening portion is used to fasten the second contact means to the housing portion. In principle, the sleeve can comprise the fastening portion for fastening the sleeve to the housing portion. Preferably, however, the grounding rod comprises the fastening portion for fastening the grounding rod to the housing portion. The discharge device has a fastening means which is designed and/or is suitable for releasably fastening the fastening portion to the housing portion. The fastening means can be disposed and/or be arrangeable form-fittingly and/or frictionally on the fastening portion in order to secure the second contact means to the housing portion. For example, the fastening portion has an external or internal thread, and the fastening means can be designed accordingly as a nut for the external thread or a screw for the internal thread. Preferably, the second contact means is connectable and/or connected to the housing portion via the fastening portion and the fastening means in a fixed manner, in particular in a rotationally fixed manner. Thus, a discharge device is proposed which can be easily installed on the housing portion and can be replaced cost-effectively during servicing.

A further object of the disclosure relates to an electric machine comprising at least or exactly one discharge device, as already described above or according to one of claims 1 to 7. In particular, the electric machine is suitable and/or is designed for a vehicle. Preferably, the vehicle is designed as an electric vehicle, in particular as a purely electric vehicle or as a hybrid vehicle. The vehicle can be designed as a single-track or two-track and/or single-axle or multi-axle, in particular two-axle, vehicle. In principle, the vehicle is designed as a passenger car, a truck or a bus. Alternatively, however, the vehicle can also be designed, for example, as an electrically driven bicycle (pedelec), motorcycle (electric motorcycle), e-scooter or similar. The electric machine serves in particular to create and/or provide a traction torque, in particular a main traction torque, for the vehicle. The electric machine can be coupled or is coupled to an energy means, in particular to an energy storage means, in particular to a battery or rechargeable battery, to obtain energy for generating the traction torque. Preferably, the electric machine is designed as an electric motor.

In a specific embodiment, it is provided that the shaft has a shaft bore that runs coaxially with respect to the main axis at the end face, wherein the sleeve is held, preferably frictionally, in the shaft bore. In particular, the shaft bore is designed as a blind hole or as a through-hole, such as in a hollow shaft. Preferably, the sleeve, in particular the contact portion and/or the sealing portion, is pressed into the shaft bore. Alternatively or optionally in addition, the housing portion has a housing bore running coaxially with respect to the main axis, the grounding rod being held, in particular frictionally, in the housing bore. In particular, the housing bore is designed as a through-hole or blind hole. Preferably, the grounding rod, in particular the fastening portion, is screwed into the housing bore and/or secured in the housing bore via the fastening means. Optionally, the discharge device has a sealing element, and the fastening portion is sealed with respect to the housing opening by the sealing element. In particular, the sealing element is used to seal the housing chamber against the ingress and/or escape of foreign particles. A discharge device is therefore proposed which can be installed particularly easily at the end face in or on the shaft. In particular, the sleeve is fastened at the end face in a bore in the rotor shaft and establishes direct contact with the rotor. On the opposite side, the grounding rod is then inserted into a housing bore and fastened to the housing, thus establishing direct contact with the stator. The structure of the shaft grounding device also allows for reversed installation in order to be able to respond to different installation spaces.

In a further specific embodiment, the housing chamber has a motor portion which is designed and/or is suitable for receiving the rotor and stator. Furthermore, the housing chamber has a transmission portion which is designed and/or is suitable for the transmission connection of the shaft to a transmission means. The transmission means can be designed as a clutch means and/or as a switching means and/or as a transmission ratio means. The shaft is connected to the transmission means for transmission, in particular the shaft forms an input shaft into the transmission means. For this purpose, the shaft can, for example, have a gearwheel portion or be fixedly connected to a gearwheel. The gearwheel portion can, for example, be formed by a tooth geometry disposed on the shaft. Alternatively, the gearwheel can be designed as a toothed wheel that is connected for conjoint rotation with the shaft. Preferably, the motor portion and the transmission portion are separated from one another, in particular in a dirt-tight and/or oil-tight manner, via a separating portion in the axial direction with respect to the main axis. Preferably, the motor portion and the transmission portion together form the housing chamber. Preferably, the shaft is guided through the separating portion and sealed with respect to the separating portion by a sealing member, e.g. another shaft sealing ring. Particularly preferably, the motor portion is realized either as an oil region or as a dry region and the transmission portion as an oil region.

According to this embodiment, the discharge device is disposed on a motor side of the motor portion. In particular, the discharge device is disposed at the end on the end face of the shaft, which is disposed in and/or guided out of the motor portion. Thus, the discharge device is disposed on the side of the rotor and installed where the electrical charge and/or electrical voltage arises in the rotor so that it can be discharged close by. Alternatively, the discharge device or, optionally, a further discharge device is disposed on a transmission side of the transmission portion. In particular, the discharge device or the further discharge device is disposed at the end on the other end face of the shaft, which is disposed in and/or guided out of the transmission portion. Therefore, the discharge device or the further discharge device is disposed on the side of the transmission means, this arrangement protecting the transmission portion with the transmission means so that any bearings in the transmission means do not suffer damage due to the passage of current.

In summary, depending on the specific embodiment, the following advantages and implementations are possible:

The grounding rod is guided via a conductive bridging sleeve and sealed from the environment by the sealing means. The bridging sleeve is used as a guide for the grounding rod (advantages in terms of fastening and emergency running properties—so the bridging sleeve is preferably a sliding bushing with conductive properties) and is used as a bridge because in such conductive liquids the conductivity decreases with increasing distance (gap). The discharge device in particular relates to the application with conductive oils and greases, which are introduced as an alternative to expensive and sometimes toxic conductive metals—i.e. the implementation is a result of the introduction of the new liquids: The electrically conductive liquid (e.g. oil, grease, liquid metal or ionic liquid, etc.) establishes a direct contact between the grounding rod and the conductive bridging sleeve and the housing connected to the sleeve. The induced currents are safely discharged to earth via this path of least resistance. Thus, the currents are discharged away from the bearing through this system. The bearings of the connected assemblies, such as the transmission, etc., are also reliably protected. The system operates particularly reliably up to gap widths of 120 μm and most efficiently in the range of 0-30 μm. A major advantage of the discharge device as a shaft grounding device is that it is built as an independent system and can therefore be provided as a finished unit. A further advantage is that the discharge device can be used in both dry and wet electric machines (carry-over part principle). Since contact is made via the electrically conductive liquid, the discharge device is completely wear-free and no conductive abrasion occurs, unlike with all currently known solutions. This means that the discharge device also operates with very little friction. The internal sealing provides additional protection for the discharge device against environmental influences that could impair efficiency. The structure also allows position-independent operation since the electrically conductive liquid always establishes contact between the two contact partners. In addition, the shaft grounding device can be replaced during servicing.

### BRIEF DESCRIPTION OF THE DRAWINGS

Further features, advantages and effects of the disclosure arise from the following description of preferred exemplary embodiments of the disclosure. In the drawings:

FIG. 1 shows a schematic sectional view of an electric machine as an exemplary embodiment of the disclosure;

FIG. 2 shows a schematic detail view of the electric machine from FIG. 1.

FIGS. 3a and 3b show different representations of a discharge device for the electric machine from FIGS. 1 and 2.

### DETAILED DESCRIPTION

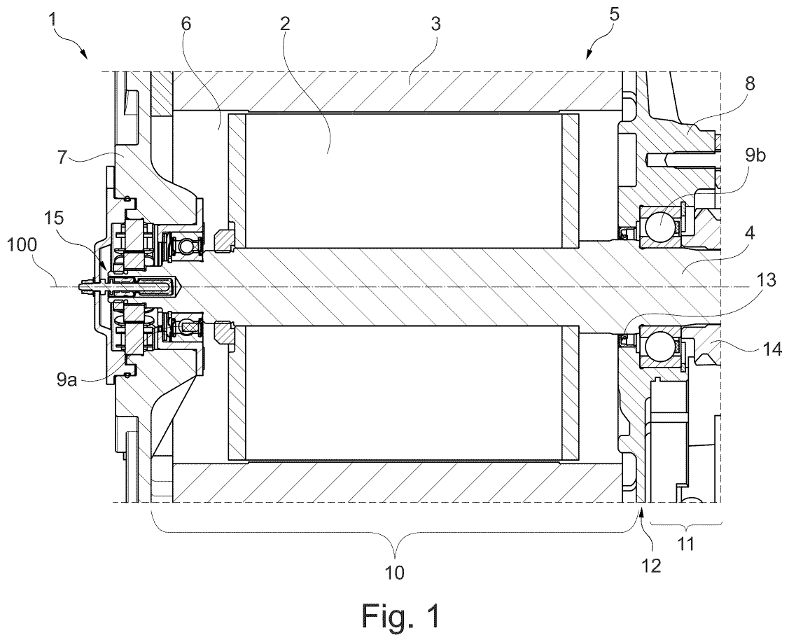

FIG. 1 shows a schematic, section representation of an electric machine 1 as an exemplary embodiment of the disclosure. For example, the electric machine is designed and/or suitable for a vehicle, in particular an electric or hybrid vehicle. The electric machine 1 is designed as an electric traction machine and is used to generate and/or provide a traction torque, in particular a main traction torque, for the vehicle. The electric machine 1 can, for example, be designed as a DC motor, a synchronous motor or an asynchronous motor.

The electric machine 1 has a rotor 2 and a stator 3, which are disposed coaxially and/or concentrically with respect to one another in relation to a main axis 100. For example, the electric machine 1 can be electrically connected to an energy means, for example a battery or a rechargeable battery, to obtain energy for generating the traction torque.

Furthermore, the electric machine 1 has a shaft 4 for transmitting the traction torque. The rotor 2 is drivingly connected to the shaft 4 so that the shaft 4 is driven via and/or by the rotor 2. The shaft 4 is thus designed as a rotor shaft and is connected to the rotor 2 mechanically, for example non-rotationally, and electrically for this purpose. The shaft 4 defines the main axis 100 with its axis of rotation.

The electric machine 1 has a housing 5 which defines a housing chamber 6. In the exemplary embodiment shown, the housing 5 is formed by the stator 3 as well as a housing portion 7 and a further housing portion 8, wherein the housing portion 7 is disposed on the one axial side and the further housing portion 8 is disposed on the other axial side of the stator 3. The housing chamber 6 is thus delimited in the radial direction by the stator 3 and in the axial direction by the two housing portions 7, 8.

The shaft 4 and the rotor 2 are rotatably mounted in the housing chamber 6 via a first and a second bearing means 9a, 9b. The two housing portions 7, 8 each form a bearing shield, the shaft 4 being supported on the housing portion 7 via the first bearing means 9a and on the further housing portion 8 via the second bearing means 9b. In the exemplary embodiment shown, the bearing means 9a, 9b are each designed as a rolling bearing/ball bearing, in particular a deep groove ball bearing.

The housing chamber 6 is divided into a motor portion 10 for receiving the rotor 2 and a transmission portion 11 for connecting the shaft 4 to a transmission means, not shown, wherein the motor portion 10 and the transmission portion 11 are spatially separated from one another via a separating portion 12 and are connected to one another for transmission via the shaft 4. For example, the separating portion 12 is formed or co-formed by the further housing portion 8.

For this purpose, the separating portion 12 is disposed in the axial direction in relation to the main axis 100 between the motor portion 10 and the transmission portion 11 and is designed as a partition wall. The motor portion 10 is designed, for example, as a dry region and the adjacent transmission portion 11 as an oil region, and the separating portion 12 forms an oil-tight separation between the motor portion 10 and the transmission portion 11. For this purpose, the shaft 4 is guided from the motor portion 10 through the separating portion 12 into the transmission portion 11 and is sealed with respect to the separating portion 12 by a shaft sealing ring 13.

The shaft 4 forms an input shaft into the transmission means. For this purpose, the electric machine 1 has a gearwheel 14 which is connected non-rotatably with the shaft 4 and is disposed in the transmission portion 11. The gearwheel 14 is designed as a toothed wheel and can, for example, be in engagement with another toothed wheel (not shown) of the transmission means in order to transmit the traction torque to the transmission means.

During operation, damaging voltages can be induced on the shaft 4 and thus in the rotor 2, resulting in a capacitive coupling between the stator 3 and the rotor 2. These voltages are usually discharged via the bearing means 9a of the motor portion 10 or partly also via the bearing means 9b of the transmission portion 11. In addition, circulating high-frequency currents can arise in the electric machine 1, particularly in AC motors of high-power classes. The circulating high-frequency currents circulate due to imbalances of the magnetic flux in the stator 3, for example through the bearing means 9a, 9b of the electric machine 1. Bearing failures can occur as a result of the discharging of damaging voltages and circulating high-frequency currents via the bearing means 9a, 9b. In this case, sparks jump over the dielectric oil or grease film, also called spark erosion, between the rotating parts and the bearing raceway, causing melt craters and/or a type of bearing profiling (grooving) in the bearing raceway of the bearing means 9a, 9b.

In order to avoid damage to the bearing means 9a, 9b, it is necessary to dissipate this electrical energy. For this purpose, the electric machine 1 has a discharge device 15. The discharge device 15 is used for discharging an electrical charge and/or electrical voltage, starting from the rotor 2 via the shaft 4 to the housing 5. The housing 5 is connected and/or grounded to earth and/or to the stator 2 so that the electrical charges and/or voltages can be safely discharged via the housing 5. For this purpose, the discharge device 15 is disposed on the motor side, in particular in the motor portion 10, on an axial end face of the shaft 4 and is electrically connected on the one hand to the shaft 4 and on the other hand to the housing 5, in particular the housing portion 7.

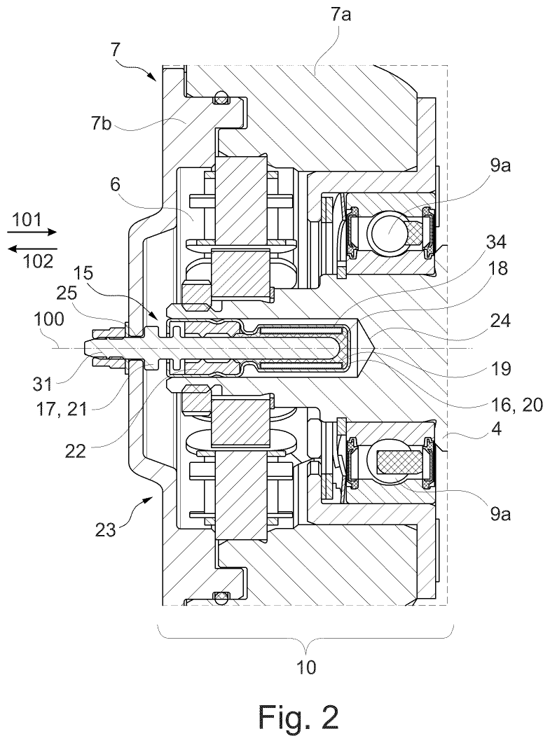

FIG. 2 shows a detail view of the motor portion 10 with the installed discharge device 15 from FIG. 1. The discharge device 15 has a first and a second contact means 16, 17, which are disposed coaxially and/or concentrically with respect to one another in relation to the main axis 100. The first contact means 16 is electrically and mechanically connected, in particular non-rotatably, to the shaft 4 and the second contact means 17 is electrically and mechanically connected, in particular non-rotatably, to the housing portion 7. The two contact means 16, 17 are mechanically decoupled from one another so that the two contact means 16, 17 can be rotated relative to each other, in particular during operation of the electric machine 1.

A contact chamber 18 designed as an annular space is formed between the first and the second contact means 16, 17, via which contact chamber the two contact means 16, 17 are electrically connected to one another. For this purpose, the contact chamber 18 is filled with an electrically conductive liquid 19, the first and the second contact means 16, 17 being electrically conductively contacted with one another by the interposition of the electrically conductive liquid 19. For example, the electrically conductive liquid is formed as an electrically conductive oil, grease, liquid metal or ionic liquid. The contact chamber 18 is separated in a fluid-tight manner from the housing chamber 6 or from the surroundings of the discharge device 15, such that the electrically conductive liquid 19 is prevented from escaping from the contact chamber 18 into the housing chamber 6 and foreign particles are prevented from entering the contact chamber 18 from the housing chamber 6. Thus, an axially acting discharge device 15 is proposed which can be used in both dry and wet environments. Since the electrical contact between the first and the second contact means 16, 17 is established by the interposition of the electrically conductive liquid 19, the discharge device 15 operates with low friction and wear-free during operation of the electric machine 1, such that no conductive abrasion can occur. Furthermore, the electrically conductive liquid 19 enables position-independent operation, since the electrically conductive liquid 19 always ensures contact between the two contact means 16, 17.

The first contact means 16 is designed as a sleeve 20 and the second contact means 17 as a grounding rod 21. The sleeve 20 is designed as a metallic, in particular electrically conductive, cylindrical sleeve that is closed in an axial direction 101 in relation to the main axis 100 and open in an opposite axial direction 102. A bridging sleeve 34 is disposed in the contact chamber 18, the bridging sleeve 34 being oriented coaxially with respect to the main axis 100. The bridging sleeve 34 has a straight hollow cylinder shape and is electrically conductive. For example, the bridging sleeve 34 is realized as a metal sleeve. The bridging sleeve 34 bears with its outer circumference against the inner circumference of the contact portion 26 in a mechanically and/or electrically conductive manner. For example, the bridging sleeve 34 is pressed into the contact portion 26. The bridging sleeve 34 forms a component of the first contact means 16.

The grounding rod 21 is designed as a metallic, in particular electrically conductive, cylindrical rod, which is inserted into the sleeve 20 in the axial direction 101 so far that the grounding rod 21 is partly immersed in the electrically conductive liquid 19 in the axial region of the bridging sleeve 34. An electrical path is thus created between the grounding rod 21 (stator) and the sleeve 20 (rotor) via the electrically conductive liquid 19 and the bridging sleeve 34. This path of least resistance safely diverts the induced currents to earth so that the currents are discharged away from the bearing through this system. The bearings of the connected assemblies, such as transmission, etc., can also be protected in this way.

The discharge device 15 has a sealing means 22, and the grounding rod 21 is guided in a sealing manner in the sleeve 20 via the sealing means 22. The sealing means 22 is disposed in the axial direction 101 in front of the contact chamber 18, and the grounding rod 21 is inserted in the axial direction via the sealing means 22 into the contact portion 26. The grounding rod 21 bears against the sleeve 20 in a sealing manner in the radial direction via the sealing means 22, such that the contact chamber 18 is sealed in the opposite axial direction 102. The internal sealing protects the contact chamber 18 from environmental influences that could impair efficiency.

The housing portion 7 has a first and a second housing part 7a, 7b, the two housing parts 7a, 7b being electrically and mechanically connected to one another. The first housing part 7a has a central housing opening 23, which is disposed in particular coaxially with respect to the main axis 100 and via which the housing chamber 6 is accessible from the outside. The second housing part 7b is designed as a housing cover which closes the housing opening 23. For example, the discharge device 15 can be installed on the shaft 4 via the housing opening 23 and then connected to the housing portion 7. For this purpose, the second housing cover 7b can be installed form-fittingly and/or frictionally, e.g. via a screw connection, in the axial direction 101 on the first housing cover 7a.

At the end face, the shaft 4 has a shaft bore 24 disposed coaxially with respect to the main axis 100, the sleeve 20 being installed form-fittingly and/or frictionally, in particular in a rotationally fixed manner, in the shaft bore 24. The second housing part 7b has a housing bore 25 disposed coaxially with respect to the main axis 100, the grounding rod 21 being installed form-fittingly and/or frictionally, in particular in particular in a rotationally fixed manner, within the housing chamber 6 in the housing bore 25. Thus, the sleeve 20 makes direct contact with the shaft 4 and the grounding rod 21 makes direct contact with the housing portion 7.

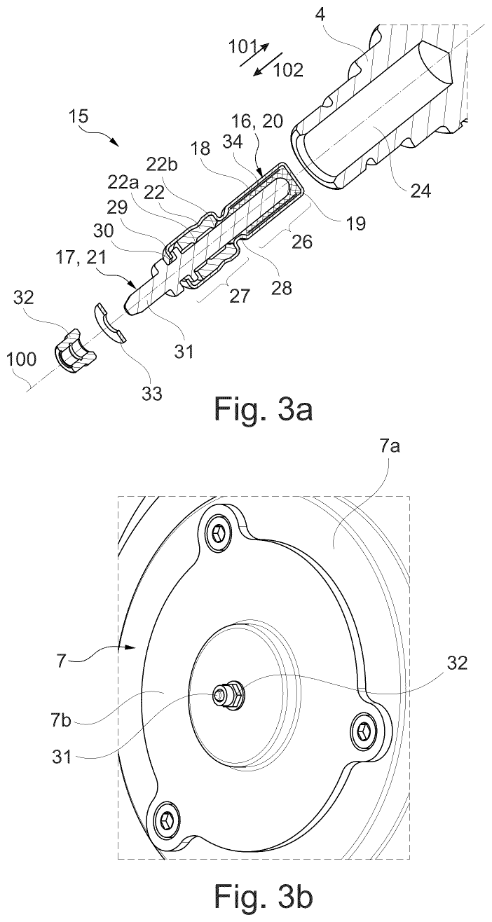

FIG. 3a shows an exploded view of the discharge device 15. The sleeve 20 has a contact portion 26 and a sealing portion 27, the contact portion 26 forming the contact chamber 18 and the sealing portion 27 forming a receptacle for the sealing means 22. The sleeve 20 is designed as a shaped sheet-metal component, the contact portion 26 and the sealing portion 27 being made by forming. The contact portion 26 has a smaller diameter than the sealing portion 27, the sleeve 20 being pressed into the shaft bore 24 via the sealing portion 27. The grounding rod 21 is disposed in the contact portion 26 in the radial direction and spaced apart from the sleeve 20 in the axial direction in relation to the main axis 100, the free space formed thereby being defined as the contact chamber 18. The bridging sleeve 34 is disposed in the contact chamber 18, the remaining free volume in the contact chamber 18 being completely or at least partially and/or largely filled with the electrically conductive liquid 19.

The bridging sleeve 34 is thus disposed concentrically between the sleeve 20 in the contact portion 26 and the grounding rod 21. Owing to the bridging sleeve 34, the electrically conductive liquid 19 does not have to bridge the radial distance between the grounding rod 21 and the sleeve 20, but instead only the annular gap between the grounding rod 21 and the bridging sleeve 34. The simple annular gap width, i.e. the simple radial distance between the outer circumference of the grounding rod 21 and the inner circumference of the bridging sleeve 34, is less than 120 μm, and, for example, less than 30 μm.

This also makes it possible, as in this exemplary embodiment, to use less conductive liquids 19, such as conductive greases or oils. The electrically conductive liquid 19 as conductive greases or oils also forms an excellent lubricant between the grounding rod 21 and the bridging sleeve 34.

The bridging sleeve 34 also enables the smaller radial distance because the bridging sleeve 34 is initially manufactured as a separate component and therefore has only low tolerances as a simple component. As a result, the inner circumference of the bridging sleeve 34 is precisely shaped so that the annular gap width can be dimensioned small.

The bridging sleeve 34 is designed in particular as a sliding bushing, the material of the sliding bushing being softer than the material of the grounding rod 21, so that emergency running properties for the rotation of the grounding rod 21 can be provided by the bridging sleeve 34.

The contact portion 26 is closed in the axial direction 101 and the sealing portion 27 is open in the opposite axial direction 102, the grounding rod 21 being guided in a sealing manner into the contact portion 26 via the sealing means 22 disposed in the sealing portion 27. The sealing means 22 is designed as a contacting rotary seal, which bears in a sealing manner, on the one hand, against an inner circumference of the sealing portion 27 and, on the other hand, against an outer circumference of the grounding rod 21. For this purpose, the sealing means 22 is designed as a cylindrical elastomer seal, which has a first and possibly a second sealing lip 22a, 22b on its inner circumference. The two sealing lips 22a, 22b are spaced apart in the axial direction in relation to the main axis 100 and circumferentially bear in a sealing manner against the outer circumference of the grounding rod 21 in the circumferential direction.

The sealing means 22 is held form-fittingly and/or frictionally in the sealing portion 27. In particular, the sealing means 22 bears in the axial direction 101 against a radial shoulder 28 of the sleeve 20, and the sleeve 20 is tapered in the region of the shoulder 28. The shoulder 28 is formed in a transition region between the contact portion 26 and the sealing portion 27, and the shoulder 28 can simultaneously form a radial stop for the grounding rod 21 in the event of unsteady rotation. The bridging sleeve 34 can rest on the axial opposite side of the radial shoulder 28. At least the free inner diameter of the radial shoulder is smaller than the outer diameter of the bridging sleeve 34, so the latter is optionally held captively in the contact portion 26.

Furthermore, the sleeve 20 has a form-fitting contour 29 on its inner circumference and the grounding rod 21 has a counter-contour 30 on its outer circumference, the form-fitting contour 29 engaging with the counter-contour 30 in order to captively secure the grounding rod 21 in the sleeve 20. The form-fitting contour 29 is formed by a radially inwardly directed collar and the counter-contour 30 by a groove which is defined by two axially spaced and radially outwardly directed collars. The collar of the form-fitting contour 29 engages in the groove of the counter-contour 30, such that the grounding rod 21 is secured in the axial direction 101 by one collar and in the opposite axial direction 102 by the other collar of the counter-contour 30. Thus, the grounding rod 21 is received captively in the sleeve 20, so the discharge device 15 can be provided as a pre-assembled unit.

At its free axial end, the grounding rod 21 has a fastening portion 31, via which the grounding rod 21 can be installed in the housing bore 25, as shown in FIG. 3b. For this purpose, the discharge device 15 has a fastening means 32 and a sealing element 33, which can be installed at the end of the fastening portion 31. During installation, the grounding rod 21 with the fastening portion 31 is pushed through the housing bore 25 and then secured to the housing portion 7, in particular the second housing part 7b, via the fastening means 32 by the interposition of the sealing element 33. The counter-contour 30, in particular the collar closest to the housing portion 7, can serve as a stop in the opposite axial direction 102 for the grounding rod 21. For example, the fastening portion 31 has an external thread, the fastening means 32 being designed as a screw nut and the sealing element 33 being designed as a sealing disk, and the sealing element 33 can be pushed onto the fastening portion 31 for installation and the fastening means 32 can be screwed onto the fastening portion 31. A discharge device 15 is thus proposed which can be easily and inexpensively installed and can be easily replaced during servicing.

### LIST OF REFERENCE SIGNS

1 Electric machine
2 Rotor
3 Stator
4 Shaft
5 Housing
6 Housing chamber
7 Housing portion
7a, b Housing parts
8 Further housing portion
9a, b Bearing means
10 Motor portion
11 Transmission portion
12 Separating portion
13 Sealing member
14 Gearwheel
15 Discharge device
16 First contact means
17 Second contact means
18 Contact chamber
19 Electrically conductive liquid
20 Sleeve
21 Grounding rod
22 Sealing means
22a, b Sealing lips
23 Housing openings
24 Shaft bore
25 Housing bore
26 Contact portion
27 Sealing portion
28 Shoulder
29 Form-fitting contour
30 Counter-contour
31 Fastening portion
32 Fastening means
33 Sealing element
34 Bridging sleeve
100 Main axis
101 Axial direction
102 Opposite axial direction

1. A discharge device for discharging an electrical charge and/or voltage to a housing portion via a shaft of a drive train of a motor vehicle, the housing portion delimiting a housing chamber, comprising:
a first contact means for electrically and mechanically connecting to the shaft,
a second contact means for electrically and mechanically connecting to the housing portion, wherein the first and the second contact means can be rotated relative to each other about a main axis,
one contact means being in the form of a sleeve and the other contact means being in the form of a grounding rod, or the one contact means being in the form of a grounding rod and the other contact means being in the form of a sleeve,
the sleeve having a contact chamber with an electrically conductive liquid, and the grounding rod being disposed partly in the sleeve so that the grounding rod is immersed in the electrically conductive liquid in the contact chamber,
the sleeve and the grounding rod being electrically interconnected by the interposition of the electrically conductive liquid,
wherein a bridging sleeve, the bridging sleeve being disposed in the contact chamber and the bridging sleeve electrically bridging a distance between the grounding rod and the sleeve at least partially.

2. The discharge device according to claim 1, wherein the bridging sleeve is designed as a sliding bushing, the sliding bushing forming a plain bearing assembly and/or an emergency bearing assembly for the grounding rod.

3. The discharge device according to claim 1, wherein the bridging sleeve is mechanically and thus electrically conductively connected to the sleeve, such that the electrically conductive liquid electrically conductively bridges a possible annular gap between the bridging sleeve and the grounding rod.

4. The discharge device according to claim 1, wherein the electrically conductive liquid is designed as a conductive oil, wherein the conductive liquid has an electrical conductivity of less than 500 nS/m at 25° C.

5. The discharge device according to claim 1, wherein the sleeve has a radial shoulder for delimiting the contact chamber, the bridging sleeve being form-fittingly secured in the contact chamber in an axial direction by the radial shoulder.

6. The discharge device according to claim 1, wherein the sleeve has a sealing portion for receiving a sealing means and a contact portion adjoining the sealing portion for forming the contact chamber, the grounding rod being guided in a sealing manner via the sealing portion into the contact portion.

7. The discharge device according to claim 6, further comprising a sealing means for sealing the contact chamber, the sealing means being received in the sealing portion form-fittingly and/or frictionally in an axial direction in relation to the main axis, the grounding rod being supported in a sealing manner on an inner circumference of the sleeve via the sealing means.

8. The discharge device according to claim 1, wherein the sleeve has a form-fitting contour on its inner circumference and the grounding rod has a counter-contour on its outer circumference, the form-fitting contour and the counter-contour engaging with one another such that the grounding rod is secured against loss in the sleeve.

9. The discharge device according to claim 1, wherein the grounding rod has a fastening portion at an end, the discharge device having a fastening means for releasably fastening the fastening portion to the housing portion.

10. A drive train of a motor vehicle, comprising an electric machine with a rotor, comprising a housing portion, the housing portion delimiting a housing chamber, and comprising a shaft, the shaft being connected electrically and for transmission to the rotor and the shaft being rotatably mounted in the housing chamber, the shaft defining a main axis, further comprising at least one discharge device according to claim 1 for discharging an electrical charge and/or voltage from the rotor to the housing portion via the shaft.
